(19) United States
(12) Patent Application Publication
(10) Pub. No.: US 2004/0111378 A1
(43) Pub. Date: Jun. 10, 2004

(54) Transaction verification

(76) Inventor: David William Howell, Westcliff-on-Sea (GB)

Correspondence Address: RENNER, KENNER, GREIVE, BOBAK, TAYLOR & WEBER, FOURTH FLOOR, FIRST NATIONAL TOWER, AKRON, OH, 44308, US

(21) Appl. No.: 10/728,018

(22) Filed: Dec. 3, 2003

(30) Foreign Application Priority Data
Dec. 4, 2002 (GB) 02 28384.4

(51) Int. Cl. G06F 17/60

(52) U.S. Cl. 705/75

(57) ABSTRACT

Apparatus and a method for verifying a credit card transaction has a server with a list stored therein, for each card holder, of transaction numbers and unique codes associated therewith. The card holder is supplied with a data carrier having a selection of those transaction numbers and unique codes. On making a purchase, the card holder supplies the transaction number and associated unique code to the vendor, who has that information checked against the server. Purchase authorisation is refused if the unique codes, for that transaction number, do not match.

### Background to the Invention

1. Field of the Invention

This invention relates to apparatus and methods for the verification of transactions to be effected by a card holder having a transaction authorisation card. The invention further relates to a data carrier for use in such a verification procedure.

2. Description of the Prior Art

A large proportion of the population has at least one transaction authorisation card (often called a “credit card”), allowing the card holder to effect purchases. The card allows a vendor to debit an account in the name of the card holder and held at a centralised transaction processing site (CTPS). The card holder then has to settle that account either in one payment by a specified subsequent date or over a period of time with a number of payments, without the vendor being involved. Transaction authorisation cards have become highly popular in view of this ability to pay for purchases over an extended period of time, though not all cards permit this; such cards are usually called “debit cards”. A further advantage of credit and debit cards is that they may be used to make purchases other than when the vendor and the purchaser are physically in the same location, for example in a shop. Thus, purchases may be made by mail order, telephone or over the Internet and it is expected that the use of cards for so-called e-commerce will rise very quickly over the coming years.

It is a fact that there is widespread misuse of transaction authorisation cards. Card issuing banks are anxious to cut back on the misuse of cards and take various measures in an attempt to do this but misuse is still increasing. There are proposals for the implementation of new systems in order to effect better checking of transactions as they occur but the difficulty is that this needs new equipment at each point of sale, new equipment at the CTPS and also new designs of cards able to handle these new proposals. For example, already some cards incorporate a microchip carrying relevant data but few vendors have equipment able to read the microchips. Also, some cards now carry a photograph of the card holder for inspection by a vendor. However, neither of these measures are of any use when a card is being used remotely to effect a transaction, such as by telephone.

The present invention aims at providing relatively simple apparatus and a method which can be used to verify the validity of a transaction as it is being effected by a card holder, and which can be implemented relatively easily, without the need for any new technology directly associated with each card, itself.

### SUMMARY OF THE INVENTION

According to a first aspect of this invention, there is provided apparatus for the verification of a transaction to be effected by a card holder having a transaction authorisation card, which apparatus comprises:

a server having stored therein a list, for each card holder intending to use a verification process running on the apparatus, of transaction numbers and for each such transaction number a respective unique code, the server running a programme for comparing the stored codes with a code to be supplied by a card holder on effecting a transaction;

a local machine whereat a transaction is to be effected which local machine is able to communicate with the server over a data-link;

a data carrier for use by a card holder and separate from the transaction authorisation card, which data carrier has a list of transaction numbers and the corresponding unique codes for those numbers;

whereby a card holder may effect a transaction at the local machine by using his authorisation card, the card holder also supplying to the local machine a transaction number and the unique code associated therewith for transmission to the server, the server comparing the supplied code with that stored in the server and allows or refuses the transaction dependent upon the result of that comparison.

According to a closely related second aspect of this invention, there is provided a method of verifying a transaction to be undertaken by a card holder having a transaction authorisation card, comprising the steps of:

programming a server with a list, for each card holder who intends to use the method, of transaction numbers and for each such transaction number a respective unique code;

providing a card holder with a data carrier having a list of transaction numbers for that card holder and the corresponding unique codes for those numbers which codes are non-sequential on any given carrier; and then in either order:—

the card holder effecting a transaction with the card; and

the card holder being asked to specify a transaction number which number is transmitted to the server, the card holder also being asked for the unique code associated with that transaction number as read from the data carrier, which unique code is transmitted to the server;

whereafter the server allows or refuses the transaction dependent upon the result of a comparison of the transmitted code with that code programmed into the server.

### BRIEF DESCRIPTION OF THE DRAWINGS

The invention will now be described in greater detail and certain specific embodiments thereof given, but solely by way of example. Reference will be made to the accompanying drawings, in which:

FIG. 1 is a diagrammatic flow chart of a preferred transaction verification sequence; and

FIGS. 2A and 2B show two possible embodiments of a credit card-sized data carrier for use in this verification sequence.

### DESCRIPTION OF THE PREFERRED EMBODIMENTS

It will be appreciated that with the apparatus and method of this invention, a card holder is issued with a data carrier which is separate from the card itself though may resemble the card, the data carrier having information on it which must be supplied in order for a transaction to be verified. However, rather than simply carrying a single code, the data carrier has a list of transaction numbers and for each such number, a corresponding unique code, which may be used only once, with a single transaction.

In order to perform the verification method of this invention, a card holder would give the vendor the card if the transaction is being effected in person, or the card number if the transaction is being effected remotely, exactly as is done at the present time. The purchaser then gives the vendor the next unused transaction number from the data carrier and the vendor enters that number into the equipment used to read the card. In this way, the transaction number is transferred back to the CTPS, which responds to the vendor with a request for the purchaser to supply the corresponding unique code. The vendor asks the purchaser to read that unique code from the data carrier and the vendor enters it into the point of sale equipment, for transfer to the CTPS. The CTPS compares the unique code entered by the vendor with that stored in a server at the CTPS, against that particular transaction number for that card holder. If a match is found, then the transaction is verified but if the result of the comparison does not produce a match, then the transaction is refused. However, the verification procedure could be arranged to permit a second attempt in order to allow for misreading of the code from the card, or incorrect entry of the code read out by the purchaser, before final refusal of the intended transaction.

In an alternative and very similar but not preferred verification method, the CTPS does not respond to the vendor by asking for entry of the corresponding unique code for the transaction number given to the vendor by the purchaser. Rather, the purchaser gives the vendor the unique code corresponding to the transaction number previously given and the vendor checks that this unique code corresponds with a code supplied to the vendor by the CTPS. The vendor may perform the comparison and then notify the CTPS accordingly, whereafter the CTPS permits or refuses the transaction.

Yet another alternative is for the CTPS to respond to entry of the card number with a request for a unique code corresponding to the next transaction number as determined by the CTPS. The CTPS will thus transfer to the vendor a request for the unique code for a given transaction number, whereafter the vendor enters the unique code as supplied by the purchaser, on checking the data carrier against the transaction number generated by the CTPS. That unique code is transferred to the CTPS for comparison with the stored code, to permit verification or refusal of the transaction.

If a second “swipe” is taken on a card without the purchaser knowing, or the number of the card is otherwise recorded, that information cannot be used to effect a second, unauthorised transaction, unless the unauthorised person is also in possession of the data card. On attempting to use that information, the unauthorised person would be unable to supply the unique code for the next transaction number on the data card and so the unauthorised purchase would fail. Even if the performance of a verified transaction is entirely monitored by an unauthorised person who thus also is able to record the transaction number and associated unique code, still no further unauthorised purchase can be made. Though that person could perhaps supply the next transaction number (presuming the card holder makes no intervening further purchase), the unauthorised person still would not be able to provide the unique code for the next transaction number.

Whereas the transaction numbers preferably advance sequentially, it is important that the unique codes do not do so. Each code should be unique for that card holder and should be “random” in the sense that given the previously used code, or even a plurality of previously used codes, the next code cannot be derived from that information. Typically, the codes each should comprise a group of alpha-numeric characters, perhaps of four to six digits in length. The alpha characters preferably are not case-sensitive, in order to facilitate the reading out of the unique code, for example when verifiying a transaction in person or by telephone.

The only way in which fraud still could be committed if the apparatus and method of this invention are implemented is if the transaction card and data carrier together fall into the hands of an unauthorised person. The alternative but not preferred verification procedure mentioned above would be open to abuse if the vendor is in collusion with the unauthorised person and thus confirms the correct supply of the unique code by the purchaser, when in fact that purchaser was unable to supply the code. However, the latter is extremely unlikely since the vendor would not be paid by the CTPS for the transaction, on it becoming apparent that such a fraud had been committed. It is for this reason that the alternative procedure is not the preferred one.

With full implementation of the preferred verification procedure, the only fraudulent transactions possible would therefore be when both a card and data carrier together are in the possession of an unauthorised person, perhaps by theft—but generally a card holder is able to report theft of a card relatively quickly, so permitting cancellation of the card and preventing continuing fraudulent use.

The individual components of apparatus used in this invention, and also as required for performing the method of this invention, are essentially standard equipment but arranged to run appropriate computer programs to ensure the required functionality. The server may be entirely conventional; the CTPS currently has several such servers running suitable programs and all that is required is a relatively minor modification to that software to ensure the storage of transaction numbers and corresponding unique codes, for each authorised card holder.

It is envisaged that the data carriers would be issued periodically to card holders and have a limited number of transaction numbers together with the corresponding unique codes, suitable for the period between issue dates. Analysis of previous transaction histories, for each user, would show how many transaction numbers should be supplied to a user to ensure that the user has sufficient transaction numbers until issue of the next data carrier. Conveniently, the data carriers might be issued monthly, with a statement in respect of a card holder's account. The system may be arranged in either one of two ways: either the card holder could use a data carrier until all transaction numbers on that carrier have been used, whereafter the card holder moves on to the next supplied carrier, or the data carrier could expire on a given date and then the card holder is required to start using the next supplied carrier. The latter is preferred, since the data carriers will expire regularly and this will also assist the prevention of fraud, in the event that a carrier has been stolen.

If a card holder believes an unusually large number of transactions will be effected within a given period, such as if the card holder is going on holiday, the card holder may ask the CTPS for a data carrier with more than usual of the predicted number of transaction numbers on it, at the time of effecting payment on a previous account. Alternatively, arrangements may be made to enable a card holder to ask for a further data carrier on a semi-automatic basis, for example by using the technology now available with modern telephones, or over the Internet.

It is important that a card holder ensures that each time a transaction is to be verified, the next available (unused) transaction number is employed. The system could be arranged to prevent verification of a transaction if the same transaction number is used twice, or if a transaction number is skipped, for either of these events might indicate an attempt at fraudulent use. In such a case, the CTPS could call for further checks before verifying a transaction, just as is sometimes employed with the current procedures.

Thus, a further aspect of this invention provides a data carrier for use in a verification procedure for a transaction by a card holder having a transaction authorisation card, which data carrier has a first data area and a second data area, the first data area having a plurality of transaction numbers marked thereon which numbers change incrementally, and the second data area having a plurality of unique codes marked thereon, one such code being associated with each transaction number respectively, whereby for a given transaction number a corresponding unique code may be read off the second data area.

In order to assist a card holder in ensuring that the next transaction number is always employed on seeking verification of a transaction, the card holder could simply strike through a used transaction number at the time it is used, with a suitable writing instrument. However, it is preferred for the unique codes to be covered with a strippable opaque coating, in the manner well known in association with so-called “scratch cards”. Then, each time a unique code for a transaction is required, the user would scratch or scrape off the opaque coating of the next unexposed code and read out the code to the vendor. This has the particular advantage that no unused code is visible and so an attempt by a fraudster to read codes from a card whilst it is being used by the proper card holder would be frustrated since no valid code could be read, only previously exposed codes which, following their use, immediately are no longer valid.

In addition to the unique codes being covered with a strippable opaque coating, so too may be the transaction numbers. Thus, this coating would also have to be stripped at the same time as the unique code. Conveniently, therefore, both numbers may be covered by a single coating which is scratched off when a transaction is to be verified. However, the preferred arrangement is for the data carrier to have a simple sequential list of numbers and alongside each a field in which is recorded the unique code for each number, those fields being covered by separate patches of the opaque coating material.

The likelihood of misuse of a data carrier may additionally be reduced, in one of several ways. For example, most card holders already have a personal identification number (PIN) associated with a transaction card. A data carrier could require validation, for example by telephone or over the Internet, by a user entering the transaction card number followed by a number printed on the data carrier and then by the user's PIN, and only if this sequence of steps is correctly performed, would the data carrier (and so the codes on it), be activated for use. Another possibility would be for a card holder to acknowledge safe receipt of the data carrier on effecting payment on the statement with which the data carrier is supplied to the card holder. It is unlikely that someone wishing to misuse the data carrier, for example following theft of a statement, would make a payment by cheque of at least part of the amount outstanding on the statement in order to acknowledge receipt of the data carrier, since the payment could be traced back to that person.

The data carrier may be modified so as to encourage a card holder to take possession of a data carrier sent to him, through the post. This may be achieved by printing a unique identifier on each data carrier sent out by the card supplier, and then for the card supplier to publish separately a short list of winning identifiers. The recipient of the data carrier would then have to examine the data carrier and check for correspondence between its unique identifier and the published list. That list may be published for example in newspapers or on the Internet, so ensuring that the recipient has to safeguard the data carrier, at least for as long as is required for its unique identifier to be checked. By delaying the publication of the list, the recipient will have to look after the data carrier at least until the list is published and so this will serve to enhance the security of the system. An alternative, but less secure, system would be for a covering letter for the data carrier to include a list of winning identifiers, for immediate comparison.

As mentioned above, the server and point of sale transaction card reader may be essentially conventional in design, construction and general functionality. It is only the programming of that equipment which needs to be revised in order to give the required functionality as hereinbefore specified.

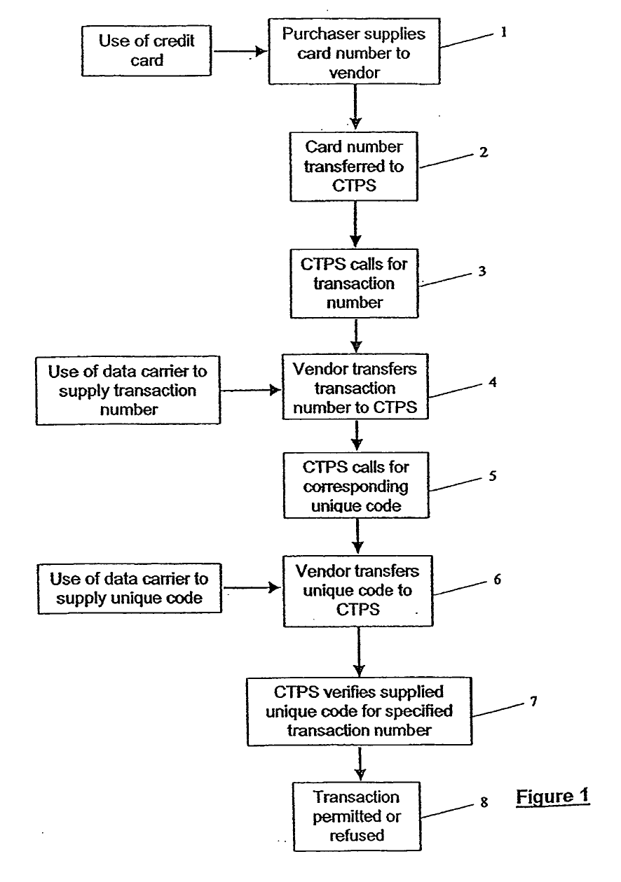

FIG. 1 shows a typical verification procedure. In step 1, a purchaser uses a credit card to make a transaction, by supplying the card number to a vendor. The vendor enters that card number into the point of sale equipment in order to transfer that card number in step 2 to a CTPS, to commence the verification procedure. In step 3, the CTPS responds by asking the vendor to enter on the point of sale equipment the next transaction number which the purchaser intends to use for this procedure. The purchaser uses the data carrier in order to see which is the next transaction number to be employed and informs the vendor; in step 4 that transaction number is transferred to the CTPS. The CTPS responds in step 5 by calling for the unique code which corresponds to that transaction number and the purchaser then uses the data carrier once more, to read off the unique code for the specified transaction number. That unique code is transferred to the CTPS in step 6 and then in step 7, the CTPS verifies the transaction by comparing the supplied unique code with that stored in a server at the CTPS. If the comparison is favourable, the transaction is permitted as shown in step 8, but if the comparison is not favourable then the transaction is refused.

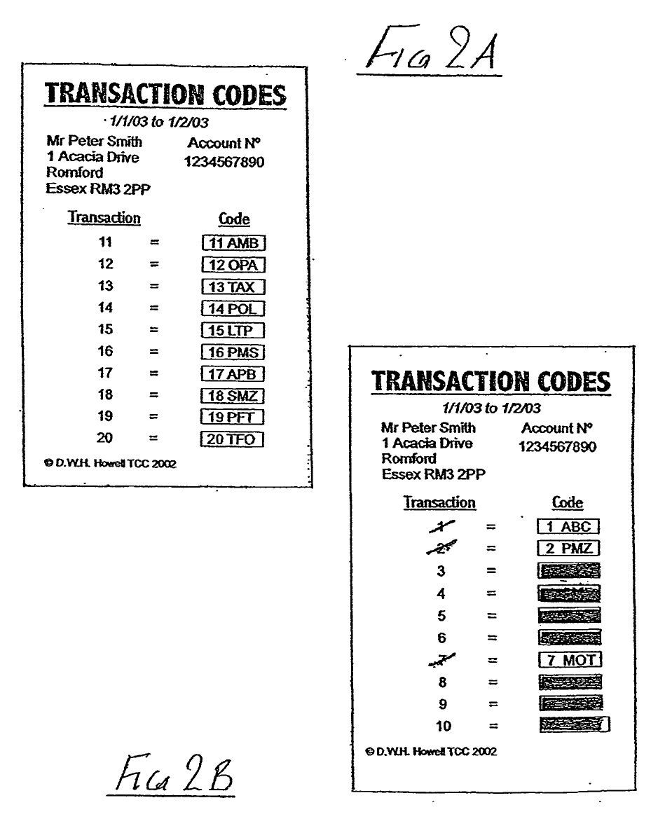

FIGS. 2A and 2B show typical data carriers for use in the procedure set out above. FIG. 2A shows a simple printed card, on an enlarged scale, which gives the name, address and account number (but not the credit card number) for the card holder. If there is no separate account number, then no separate identifying number appears on the data carrier. In column 10, there is a list of transaction numbers and alongside each a unique code for each transaction. As the purchaser uses the data carrier, he may strike through with a pen at least one of the transaction number or unique code, so that it is immediately apparent which is the next transaction number and unique code to employ. The data carrier also includes valid from and valid to dates and once the valid to date has been reached, then the card holder must start using a replacement data carrier.

In FIG. 2B, there is shown a variation of the data carrier of FIG. 2A. Here, each of the unique codes is obscured with an opaque coating which may easily be removed by scratching, as with a conventional scratch card. As with the previous example, the transaction numbers are used one at a time but each time a new unique code is required, that code must be exposed. Further, the data carrier of FIG. 2B shows that it might, for some verification procedures, be possible to use the transaction numbers out of sequence, so long as only one transaction number is employed at a time.

The reverse of the data carriers shown in FIGS. 2A and 2B may have continuation transaction numbers and unique codes, if it is expected that a card holder will use more than the number of transaction numbers and codes set out on the front face. In the alternative, advertising material may be carried on the reverse, so helping defray the cost of deploying the verification procedure.

Though not shown in the drawings, the data carrier of FIGS. 2A and 2B may carry a unique identifier such as a collection of letters and numbers, for matching with a published list. If a match is found, the holder of the data carrier may win a prize—and this will serve to enhance security, by encouraging the card and data carrier holder to safeguard the data carrier.

I claim:

1. Apparatus for the verification of a transaction to be effected by a card holder having a transaction authorisation card, which apparatus comprises:
a server having stored therein a list, for each card holder intending to use a verification process running on the apparatus, of transaction numbers and for each such transaction number a respective unique code, the server running a programme for comparing the stored codes with a code to be supplied by a card holder on effecting a transaction;
a local machine whereat a transaction is to be effected which local machine is able to communicate with the server over a data-link;
a data carrier for use by a card holder and separate from the transaction authorisation card, which data carrier has a list of transaction numbers and the corresponding unique codes for those numbers;
whereby a card holder may effect a transaction at the local machine by using his authorisation card, the card holder also supplying to the local machine a transaction number and the unique code associated therewith for transmission to the server, the server comparing the supplied code with that stored in the server and allows or refuses the transaction dependent upon the result of that comparison.

2. Apparatus as claimed in claim 1, wherein said local machine comprises a conventional point of sale card reading machine able to communicate with a centralised server.

3. Apparatus as claimed in claim 1, wherein said transaction authorisation card comprises a conventional credit card or debit card.

4. Apparatus as claimed in claim 1, wherein said data-link comprises a conventional public telephone network service.

5. Apparatus as claimed in claim 4, wherein said data carrier has a first data area and a second data area, the first data area having a plurality of transaction numbers marked thereon which numbers change incrementally, and the second data area having a plurality of unique codes marked thereon, one such code being associated with each transaction number respectively, whereby for a given transaction number a corresponding unique code may be read off the second data area.

6. Apparatus as claimed in claim 5, wherein the unique codes of the data carrier are covered with a strippable opaque coating, whereby each unique code may be exposed by removing the strippable coating therefrom.

7. Apparatus as claimed in claim 6, wherein the transaction numbers of the data carrier and associated with the unique codes are also covered with a strippable opaque coating, whereby the next transaction number and its associated code are together exposed when required for use.

8. A method of verifying a transaction to be undertaken by a card holder having a transaction authorisation card, comprising the steps of:
programming a server with a list, for each card holder who intends to use the method, of transaction numbers and for each such transaction number a respective unique code;
providing a card holder with a data carrier having a list of transaction numbers for that card holder and the corresponding unique codes for those numbers which codes are non-sequential on any given carrier; and then in either order:—
the card holder effecting a transaction with the card; and
the card holder being asked to specify a transaction number which number is transmitted to the server, the card holder also being asked for the unique code associated with that transaction number as read from the data carrier, which unique code is transmitted to the server;
whereafter the server allows or refuses the transaction dependent upon the result of a comparison of the transmitted code with that code programmed into the server.

9. A method as claimed in claim 8, in which the data carrier is valid for a limited period and is replaced periodically with a fresh supply of transaction numbers and corresponding unique codes.

10. A method as claimed in claim 8, in which the data carrier is valid for only a specified number of transactions and is replaced with a fresh supply of transaction numbers and corresponding unique codes when that specified number of transactions has been effected.

11. A method as claimed in claim 8, in which the data carrier must be activated following receipt thereof by a card holder, before the data carrier may be employed to verify transactions.

12. A method as claimed in claim 8, in which the server permits at least a second attempt at verifying a transaction, in the event that the first attempt results in a refusal of the transaction.

13. A method as claimed in claim 8, in which the server communicates with a vendor having control of a point of sale local machine and the vendor requests the relevant information from the card holder and acts as an intermediary between the card holder and the server.

14. A method as claimed in claim 8, in which the transaction authorisation card comprises one of a credit card or a debit card.

15. A method as claimed in claim 14, in which a fresh data carrier is supplied to the card holder with a statement of transactions effected over a previous period.

16. A modification of the method as claimed in claim 8, in which modification the server generates the transaction number to be used to verify a transaction and returns that transaction number to the card holder so that the card holder may supply the server with the corresponding unique code from the data carrier, for verification.

17. A data carrier for use in a verification procedure for a transaction by a card holder having a transaction authorisation card, which data carrier has a first data area and a second data area, the first data area having a plurality of transaction numbers marked thereon which numbers change incrementally, and the second data area having a plurality of unique codes marked thereon, one such code being associated with each transaction number respectively, whereby for a given transaction number a corresponding unique code may be read off the second data area.

18. A data carrier as claimed in claim 17, wherein the unique codes are covered with a strippable opaque coating, whereby each unique code may be exposed by removing the strippable coating therefrom.

19. A data carrier as claimed in claim 18, wherein the transaction numbers associated with the unique codes are also covered with a strippable opaque coating, whereby the next transaction number and its associated code are together exposed when required for use.
